(19) United States
(12) Patent Application Publication
(10) Pub. No.: US 2026/0285392 A1
(43) Pub. Date: Sep. 24, 2026

(54) TRIM ELEMENT FOR A VEHICLE STEERING WHEEL

(71) Applicant: Autoliv Development AB, Vargarda (SE)

(72) Inventors: Arthur MEUNIER, Vargarda (SE); Sébastien CASSIN, Vargarda (SE); Laurent GROLEAU, Vargarda (SE)

(21) Appl. No.: 19/472,468

(22) PCT Filed: Apr. 4, 2024
(86) PCT No.: PCT/EP2024/059221

§ 371 Date: Oct. 3, 2025

(30) Foreign Application Priority Data
Apr. 4, 2023 (FR) FR2303310

(51) Int. Cl. B62D 1/06; B62D 1/04; H05B 3/54

(52) U.S. Cl. CPC B62D 1/065; B62D 1/046; H05B 3/54

(57) ABSTRACT

A trim element to be mounted on a vehicle steering wheel, including comprising at least a flexible substrate, designed to cover part of the vehicle steering wheel once the trim element has been mounted on the vehicle steering wheel, an attachment portion, separate from the flexible substrate and having an attachment shape such as a male attachment shape or a female attachment shape, where the attachment portion is designed to be attached, at least during part of, and/or after, an operation of mounting the trim element on the vehicle steering wheel, on a fastening interface of the vehicle steering wheel, having a fastening shape such as a female fastening shape or a male fastening shape.

### TECHNICAL FIELD OF THE INVENTION

The present invention relates generally to trim elements for vehicle steering wheels. In particular, the present invention relates to trim elements comprising one or more flexible parts intended to cover parts of the vehicle steering wheel.

### PRIOR ART

It is known, from the prior art of vehicle steering wheels, to provide trim elements to be mounted on the vehicle steering wheel. For example, flexible sheaths can be bonded to all or part of a vehicle rim. On the other hand, these flexible sheaths can be difficult to mount in such a way that they are well positioned, wrinkle-free, and seamless with the other components of the vehicle steering wheel.

### DISCLOSURE OF THE INVENTION

An object of the present invention is to overcome the shortcomings of the background art mentioned above and in particular, firstly, to propose a trim element able to simplify mounting onto the vehicle steering wheel.

To this end, a first aspect of the invention relates to a trim element to be mounted on a vehicle steering wheel, comprising at least:
a flexible substrate, designed to cover part of the vehicle steering wheel once the trim element has been mounted on the vehicle steering wheel,
an attachment portion, separate from the flexible substrate and having an attachment shape such as a male attachment shape or a female attachment shape,
wherein:
the attachment portion is designed to be attached, at least during part of, and/or after, an operation of mounting the trim element on the vehicle steering wheel, on a fastening interface of the vehicle steering wheel, having a fastening shape such as a female fastening shape or a male fastening shape.

According to the above implementation, the attachment portion (separate from the flexible substrate) can be attached, at least during part of, and/or after, an operation of mounting the trim element on the vehicle steering wheel, to the fastening interface of the vehicle steering wheel. Such an attachment allows a user to subsequently position the trim element on the vehicle steering wheel to precisely mount/position the trim element and, for example, tension it. In other words, the above implementation proposes an element or part dedicated and/or attached to and/or separate from the flexible substrate and intended to be fixed to the steering wheel to subsequently allow an operator to pull, position, move the trim element before finishing mounting it on the steering wheel, the operator having both hands free to perform these operations. Typically, the trim element is sheathed on a vehicle steering wheel rim or on a vehicle steering wheel peripheral zone used to steer the vehicle. Typically, the trim element is sheathed over all or most of the rim or peripheral zone of a vehicle steering wheel.

The trim element can be defined by the following features, taken either individually or in combination.

In one embodiment, the fastening shape can be complementary to the attachment shape. In other words, the fastening shape can be designed to couple mechanically with the attachment shape.

In one embodiment, the flexible substrate can be arranged to cover at least part of the attachment portion once the trim element has been mounted on the vehicle steering wheel. The trim element can therefore cover itself, concealing at least part of the attachment portion. Perceived quality is improved.

In one embodiment, the trim element may comprise at least two attachment portions, at least one of said at least two attachment portions may be arranged to be attached, at least during part of a mounting operation of the trim element on the vehicle steering wheel, to a dedicated fastening portion of the fastening interface of the vehicle steering wheel.

In one embodiment, said at least two attachment portions can each be arranged at one end of the flexible substrate. In one embodiment, the flexible substrate can have an elongate shape in an axial direction, and said at least two attachment portions can each be arranged at one end of the flexible substrate in the axial direction.

In one embodiment, one of said at least two attachment portions can be arranged to attach to or snap onto the other of said at least two attachment portions. In other words, the trim element attaches to itself, but at least one of the attachment portions is attached to the vehicle steering wheel (at the fastening interface). Forces are absorbed better.

In one embodiment, the trim element may comprise a plurality of attachment portions distributed along the trim element, to absorb force on the vehicle steering wheel during assembly. Perceived quality is improved, and the risk of wrinkles or appearance defects is reduced.

In one embodiment, the attachment portion may have:
a first interface surface in contact with the flexible substrate,
a second interface surface arranged to be in contact with the fastening interface,
the first interface surface can be greater than the second interface surface, preferably the first interface surface is greater than 120% of the second interface surface, preferably the first interface surface is greater than 160% of the second interface surface, preferably the first interface surface is greater than twice the second interface surface. This type of implementation ensures a good distribution of forces between the attachment portion and the flexible substrate. The risk of wrinkles, tears or defects is reduced.

In one embodiment, the attachment portion can be stiffer than the flexible substrate. In one embodiment, the attachment portion can be a polymer part (plastic, polyamide, polyethylene, etc.) attached to the flexible substrate.

In one embodiment, the first interface surface may extend over more than 5 mm, more than 7 mm, more than 10 mm, more than 15 mm, in a direction normal to a direction of application of a mounting force exerted on the flexible substrate, or in an axial or longitudinal direction of the flexible substrate, lain flat before mounting. This type of implementation ensures a good distribution of forces between the attachment portion and the flexible substrate. The risk of wrinkles, tears or defects is reduced.

In one embodiment, the attachment portion can be arranged to support or resist a mounting force such as a tensile or tension force to stretch the trim element. In other words, the attachment portion is designed to allow the trim element to be tensioned (unfolded) during assembly. Such a function eliminates the risk of tears during assembly.

In one embodiment, the attachment portion can be attached to the flexible substrate by gluing and/or adhesive and/or welding and/or overmolding.

In one embodiment, the attachment portion can be at least partially arranged in a fold of the flexible substrate or in a return fold of the flexible substrate. The connection between the two parts is solid.

In one embodiment, the trim element may comprise an adhesive film arranged on the flexible substrate and arranged at least in part between the flexible substrate and the attachment portion.

In one embodiment, the adhesive film can be arranged to attach the flexible substrate to the vehicle steering wheel. The same adhesive film can be used to attach the flexible substrate to the vehicle steering wheel and to attach the attachment portion to the flexible substrate.

In one embodiment, the attachment portion can be arranged to fit onto the fastening interface, by resilient or sliding engagement.

In one embodiment, sliding engagement can take place in a direction parallel to a direction of application of a force for mounting the trim element on the vehicle steering wheel, or in a direction parallel to an axial or longitudinal direction of the flexible substrate or the trim element.

In one embodiment, the attachment portion can be arranged to receive a fastening element, such as a pin with a resilient base.

In one embodiment, the trim element can form a sheath to be placed on a part of the vehicle steering wheel and in particular on a vehicle steering wheel rim or on a vehicle steering wheel peripheral zone used to steer the vehicle. In one embodiment, the trim element can form an inner (invisible) layer of the vehicle steering wheel. In one embodiment, the trim element can form an outer (visible) layer of the vehicle steering wheel.

In one embodiment, the flexible substrate may comprise or may form an electrically conductive element.

In one embodiment, the trim element can form a heating element.

In one embodiment, the flexible substrate can comprise or can form a heating element or an element forming part of a capacitive detection sensor.

In one embodiment, the trim element can form a detection sensor, such as a sensor for detecting contact or proximity of the vehicle steering wheel with a user's limb.

In one embodiment, the flexible substrate may comprise or may form a decorative element, arranged to be visible, such as an outer casing of the vehicle steering wheel. The flexible substrate can be natural or artificial leather.

A second aspect of the invention relates to a safety module comprising:
at least one trim element according to the first aspect,
a fastening interface, formed in a foam of the vehicle steering wheel or in an insert of the steering wheel and separate from the foam,
wherein the fastening interface receives or interfaces at least partially with the two attachment portions.

In one embodiment, the fastening interface can be formed in a frame of the vehicle steering wheel.

A third aspect of the invention relates to a safety module comprising:
at least one trim element according to the first aspect,
a fastening interface,
wherein:
the fastening interface can be formed in a foam of the vehicle steering wheel or in an insert of the steering wheel and separate from the foam, and/or
said at least one attachment portion and/or the fastening interface may form a finishing groove; the finishing groove may receive an outer sheath seam and/or a decorative part. In this way, the at least one attachment portion and/or the fastening interface are advantageously concealed from a user of the vehicle steering wheel.

In one embodiment, the vehicle steering wheel may comprise a gripping part (e.g. a rim or handle) to be gripped for steering the vehicle, and the trim element may be mounted at least partially around or on the gripping part.

### DESCRIPTION OF THE FIGURES

Other features and advantages of the present invention will become more apparent upon reading the following detailed description of embodiment(s) of the invention, which are provided by way of example but in no manner limited thereto, and illustrated by the attached drawings, wherein:

FIG. 1 shows a vehicle steering wheel comprising a rim covered with an outer sheath, spokes, a hub and a trim element not visible to an end user of the vehicle according to the invention;

FIG. 2 shows a detail of zone Il of FIG. 1, showing a part of the rim without the outer sheath and covered by the trim element, which is therefore visible in FIG. 2;

FIG. 3 shows the rim section of FIG. 2 without the trim element, to illustrate an indentation formed in a foam of the steering wheel in zone II, the indentation being able to receive attachment portions of the trim element covering the rim;

FIG. 4 shows two attachment portions in perspective, connected to a flexible substrate of the trim element, seen from below, that is to show a face of the two attachment portions facing the rim and in the indentation of FIG. 3;

FIG. 5 shows the two attachment portions of FIG. 4, without the flexible substrate;

FIG. 6 shows a cross-section of the vehicle steering wheel along an axis I-I of FIG. 1;

FIG. 7 shows a cross-section of the vehicle steering wheel along an axis III-III of FIG. 6;

FIG. 8 shows a cross-section of a first variant of the vehicle steering wheel along an axis I-I of FIG. 1;

FIG. 9 shows a view of a second variant of the vehicle steering wheel of FIG. 1, wherein the trim element is visible to an end user of the vehicle.

### DETAILED DESCRIPTION OF EMBODIMENT(S)

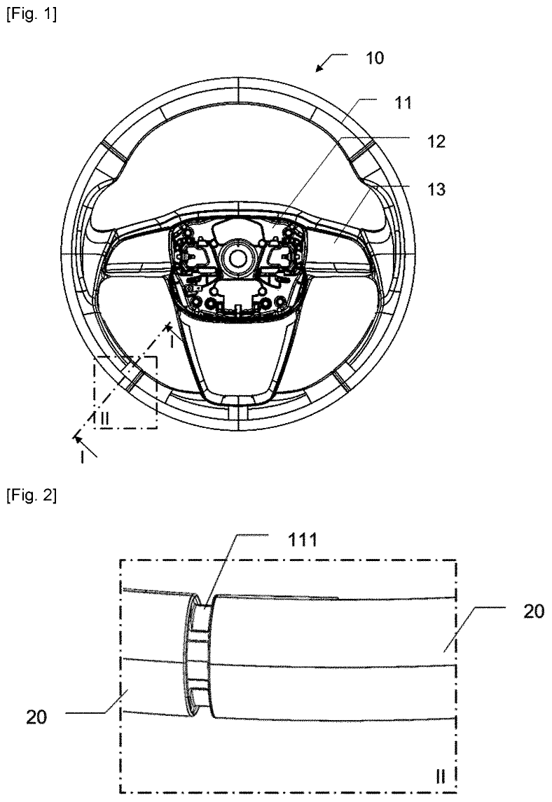

FIG. 1 shows a vehicle steering wheel 10 comprising a rim 11, a hub 12, spokes 13 connecting the hub to the rim 11, and a trim element 20 according to the invention, not visible as it is arranged under an outer sheath, typically made of leather. In the example shown in FIG. 1, the trim element 20 covers the entire periphery of the rim, but any other type of distribution or arrangement is possible. In particular, a plurality of trim elements could be distributed along the periphery. In this case, one or more keying features (or poka-yokes) can be provided on the respective attachment portions.

FIG. 2 shows a detail of a zone Il of FIG. 1 to show part of the rim 11 of FIG. 1 without the outer sheath, the two ends of the trim element 20 being separated by a groove 111 in the rim 11 running around it. The groove 111 is designed to receive a seam in the outer sheath. In another embodiment, the groove 11 can accommodate a decorative part such as a ring.

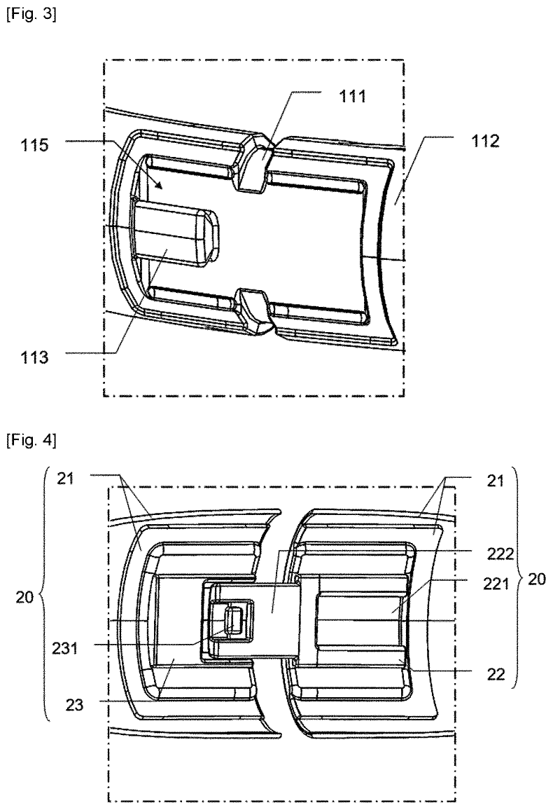

FIG. 3 shows the part of rim 11 from FIG. 2, without the trim element 20, to show an indentation 115 formed in a foam 112 (typically made of polyurethane, for example) of the steering wheel in zone Il. In the present disclosure, indentation 115 can receive attachment portions of trim element 20 covering the rim. To this end, the indentation 115 comprises a fastening protuberance 113 which forms a male fastening shape for hooking onto an attachment portion of the trim element 20. In the example shown, the fastening protuberance 113 forms a dovetail-shaped male part, to provide the possibility of sliding on an attachment portion of the trim element 20.

Note that the groove 111 opens out into the indentation 115, which in turn forms a recessed cradle in the foam 112 of the rim 11 to accommodate the attachment portions of trim element 20. In an alternative embodiment, indentation 115, attachment protrusion 113 and/or groove 111 can be formed in a steering wheel insert separate from the foam 112 (visible, such as a wood-or carbon-coated part, or concealed, such as a sheathing reinforcement); the attachment protrusion 113 and/or groove 111 can also be formed in the frame 114 of the vehicle steering wheel (visible in FIG. 6).

FIG. 4 shows two attachment portions 22 and 23 in perspective, connected to a flexible substrate 21 of the adjacent trim element 20 of the rim 11. The two attachment portions 22 and 23 are seen from below, that is to show a face of the two attachment portions 22 and 23 facing the rim and housed in the indentation 115 of FIG. 3.

The flexible substrate 21 is or comprises, for example, an electrically conductive element. In fact, trim element 20 may form part of a vehicle electrical circuit: a heating device (trim element 20 forms or comprises a heating mat), or a device for detecting contact or proximity with a user (trim element 20 forms or comprises or forms part of a detection sensor, typically a capacitive sensor). The flexible substrate 21 may be or may comprise, for example, an elastic element (an operator may significantly deform it by exerting a pull on the flexible substrate 21 when it is mounted on the steering wheel). The flexible substrate 21 may be a sheet or a surface component of constant or substantially constant thickness. The flexible substrate 21 may have a thickness of less than 1.5 mm, less than 1 mm. The flexible substrate 21 may be a woven, non-woven, injection-molded or printed material, or a combination of these.

Specific attachments, such as polymer parts (plastic, polyamide, polyethylene, etc.) attached to the flexible substrate 21, may be provided for the attachment portions 22 and 23. In any case, it may be envisaged that the attachment portions 22 and 23 comprise at least one part that is notably more rigid than the flexible substrate 21. In particular, it may be envisaged that the attachment portions 22 and 23 comprise at least one part notably thicker than the flexible substrate 21 (for example a part at least twice, three times as thick as the flexible substrate 21).

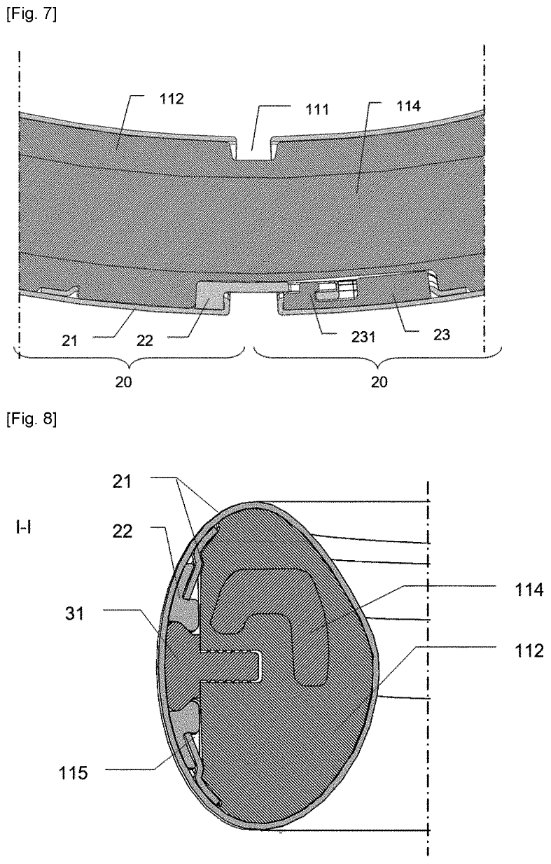

The trim element 20 comprises an attachment portion 22 and an attachment portion 23. The attachment portion 22 and attachment portion 23 are each coupled to the flexible substrate 21, and provision may be made to fold part of the flexible substrate 21 over the attachment portion 22 and the attachment portion 23 to secure the attachment portion 22, the attachment portion 23 and the flexible substrate 21 together. FIG. 4 shows the flap of the flexible substrate 21, so that the lateral parts of the attachment portion 22 and attachment portion 23 are sandwiched or interposed between the flexible substrate 21 and its foldable flap. The flaps can also be seen in FIGS. 6 and 7.

In particular, the attachment portion 22 comprises a tongue 222 having a receiving hole, and the attachment portion 23 comprises a hook 231 whose end is engaged in the receiving hole of the tongue 222.

It may also be noted that the attachment portion 22 comprises a groove 221 which is a counter-shape of the fastening protuberance 113 formed in the indentation 115. As a result, the attachment portion 22 may be attached to the foam 112 (that is to the rim 11) with a sliding movement that ends with the attachment portion 22 abutting a wall of the indentation 115, and an operator may then pull on the remainder of trim element 20 to mount/set/position the trim element 20 on the rim 11. As the trim element 20 is attached to the rim 11 by the attachment portion 22, this mounting operation is facilitated, as the operator has both hands free once the attachment portion 22 is engaged on the fastening protuberance 113. In addition, optimum positioning of the trim element 20 relative to the steering wheel is guaranteed.

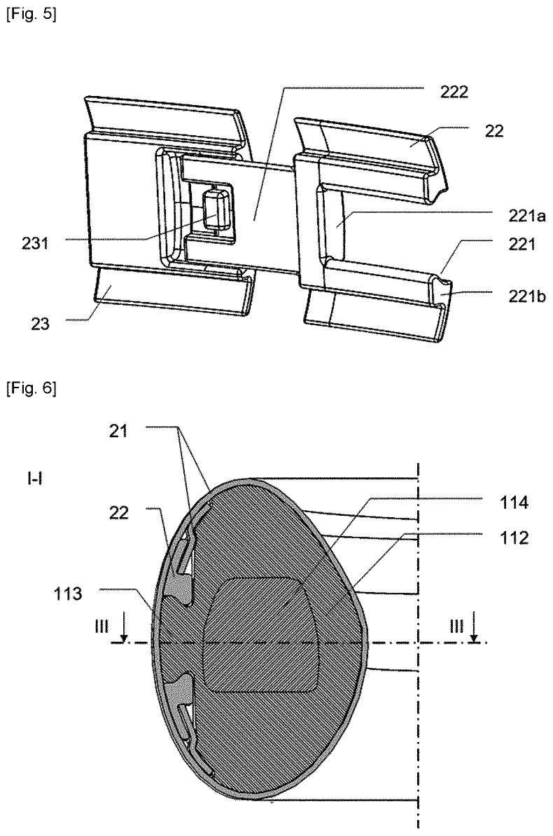

FIG. 5 shows the two attachment portions 22 and 23 of FIG. 4, without the flexible substrate 21. This figure clearly shows the groove 221 of the attachment portion 22 and the hook 231, the end of which is engaged in the hole for receiving the tongue 222. It may also be noted from FIG. 5 that the attachment portion 22 comprises two stop surfaces 221a and 221b designed to abut on the foam 112 of the rim 11 when the operator pulls on the flexible substrate 21 to stretch or sheath it around the rim 11. In the example shown in FIG. 5, the two stop surfaces 221a and 221b are normal to the sliding direction defined by the groove 221, but other implementations are possible.

FIG. 6 shows a cross-section of the vehicle steering wheel along an axis I-I of FIG. 1. It can be seen from FIG. 6 that rim 11 comprises a frame 114 (typically made of magnesium, for example) which forms a core of the vehicle steering wheel 10.

It may also be noted that the lateral parts of the attachment portion 22 are arranged between the outer part of the flexible substrate 21 and the inner flap of the flexible substrate 21. With or without the flap, the attachment portion 22 or 23 has a large contact surface with the flexible substrate 21, so that the forces exerted on the flexible substrate 21 are well distributed and transmitted to the attachment portion 22 or 23, which limits the risk of folds, wrinkles, ripples and tears in the flexible substrate 21. Note that the attachment portion 22 is arranged between the outer face of the flexible substrate 21 and the foam 112. In this way, the flexible substrate 21 may help conceal the user's grip portion 22 from the vehicle steering wheel 10.

Adhesive film or glue can be used to attach these parts together. The adhesive film or glue can also cover all or part of the inner face of the outer part of the flexible substrate 21 to bond it to the rest of the foam 112 of the rim 11.

FIG. 7 shows a cross-section of the steering wheel of the vehicle 10 along an axis III-III of FIG. 6. FIG. 7 shows the connection between the two ends of trim element 20. The left-hand side of trim element 20 comprises attachment portion 22, and the right-hand side of trim element 20 comprises attachment portion 23. It may be noted that the hook 231 of the attachment portion 23 is engaged in the receiving hole of the tongue 222 of the attachment portion 22.

It can also be seen in the upper part of FIG. 7 that the left and right edges of the flexible substrate 21 of the trim element 20 face the groove 111. Once the trim element 20 is covered by an outer sheath, a seam or decorative piece can fill the groove 111 and give the vehicle steering wheel 10 an attractive external appearance.

Finally, it may also be considered that the attachment portion 23 is attached to the fastening interface (the fastening protuberance 113), at least indirectly, via the attachment portion 22. In any case, as the attachment portion 22 is attached to the rim 11 (the fastening protuberance 113) during the assembly of the trim element 20, the tensile or tension forces exerted by the operator are transmitted directly to the internal structure of the vehicle steering wheel 10. Finally, as the attachment portion 23 picks up on the attachment portion 22, the forces are also picked up.

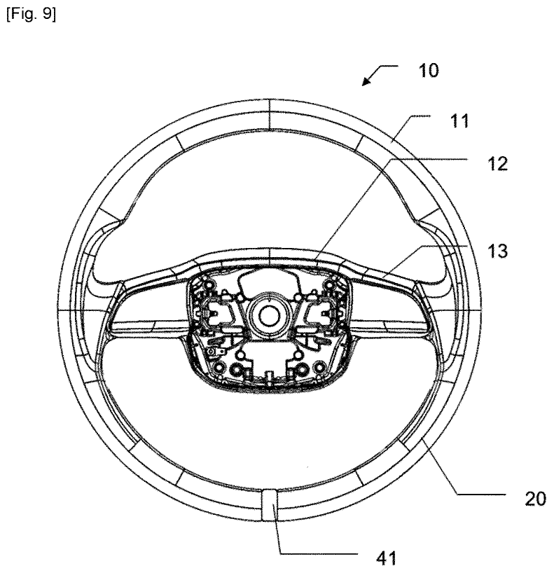

FIG. 8 shows a cross-section of a first variant of the vehicle steering wheel along an axis I-I of FIG. 1. In this variant, the fastening protuberance 113, visible in FIG. 2, 6 or 7, is replaced by a fastening element formed, in this FIG. 8 example, by a fir-tree-shaped pin 31.

In more detail, the foam 112 is provided with a blind hole located at the bottom of indentation 115, and during assembly, an operator can position attachment portion 22 (integral with the flexible substrate 21) in the indentation 115, and thread the fir-tree-shaped pin 31 into the blind hole, through the through-hole in tongue 222 of the attachment portion 22. In this way, the fastening or attachment of the attachment portion to the rim 11 is carried out at the very beginning of mounting the trim element (as for the variant with the fastening protuberance 113 of FIG. 2), and this allows the rest of the trim element 20 to be pulled or repositioned on the rim 11. The same fastener can be used to secure the attachment portion 23, which may or may not be connected to the attachment portion 22.

FIG. 9 shows a second variant of the vehicle steering wheel 10 of FIG. 1. In the second variant shown in FIG. 9, the trim element 20 is visible. In particular, the trim element 20 forms the outer sheath covering the rim 11 (leather or any other material may be used). In this example, the trim element 20 comprises a flexible substrate which has an elongate flat shape and two ends, each equipped with an attachment portion similar to that described with reference to FIGS. 4 to 7.

An indentation similar to the indentation 115 in FIG. 3 can be provided, for example in the rim 11 foam, at the bottom location in FIG. 9, at 6 o'clock, and the two attachment portions of trim element 20 can be attached to the rim 11 and/or to each other in this indentation at 6 o'clock. A decorative part (e.g. a ring 41) can then be added to cover the junction zone, providing an attractive appearance for the user. The ring 41 can be clipped, glued or welded onto the trim element 20. The ring 41 can be formed in two parts that fit together around the rim 11.

To mount the trim element 20 around the rim 11, the mounting operator may attach an attachment portion to the rim 11, then pull on the free end of the trim element 20 to tension the flexible substrate and lay/position/bond it around the rim 11 without folds, creases, wrinkles, tears, and finally attach the attachment portion of the free end to the rim 11, directly and/or via the attachment portion initially attached to the rim 11.

### Industrial Application

A trim element and a vehicle steering wheel according to the present invention, and its manufacture, are capable of industrial application.

It will be understood that various modifications and/or improvements which are obvious to a person skilled in the art may be made to the different embodiments of the invention described in the present description without departing from the scope of the invention.

In particular, in the case shown, one trim element 20 covers the entire periphery of the steering wheel, but a different number of trim elements 20 can be provided (e.g. a plurality of trim elements 20). It is also possible to cover non-adjacent parts, parts other than the rim, a rear face or a front face of the rim, etc. It is also possible to have an attachment portion 23 overlap the attachment portion 22 of an adjacent trim element.

It should be noted that in the case shown, the trim elements 20 form heating devices, which will therefore be covered by an outer sheath of the vehicle steering wheel. However, the trim elements 20 cover part of the rim 11 and are considered to be parts that at least partially cover the vehicle steering wheel at some point during its manufacture. As shown, the trim element 20 can be invisible to the end user of the vehicle, but the trim element 20 can also be visible to the end user. In this case, the attachment portion(s) 22, 23 can be concealed by a decorative piece.

In the example given, the flexible substrate is attached to the attachment portions 22 and 23 by an adhesive (film, glue), but welding (ultrasound, heat), overmolding or even mechanical assembly (by staples, sewing, etc.) can also be used.

Finally, the attachment portion 22 could be thought of as forming a first attachment portion 22 and the attachment portion 23 as forming a second attachment portion 23. Alternatively, the attachment portion 22 could be thought of as forming one attachment portion 22 and the attachment portion 23 as forming another attachment portion 23. In other words, the attachment portion 22 and the attachment portion 23 can be linked to the steering wheel without being linked to each other.

1. A trim element for mounting on a vehicle steering wheel, comprising at least:
a flexible substrate, designed to cover part of the vehicle steering wheel once the trim element has been mounted on the vehicle steering wheel,
an attachment portion, separate from the flexible substrate and having an attachment shape such as a male attachment shape or a female attachment shape, wherein:
the attachment portion is designed to be attached, at least during part of and/or after an operation of mounting the trim element on the vehicle steering wheel, on a fastening interface of the vehicle steering wheel, comprising a fastening shape such as a female fastening shape or a male fastening shape.

2. The trim element according to claim 1, wherein the flexible substrate is arranged to cover at least part of the attachment portion once the trim element has been mounted on the vehicle steering wheel.

3. The trim element according to claim 1, comprising at least two attachment portions, at least one of said at least two attachment portions is arranged to be attached, at least during part of an operation for mounting the trim element on the vehicle steering wheel, to a dedicated fastening portion of the fastening interface of the vehicle steering wheel.

4. The trim element according to claim 3, wherein the flexible substrate has an elongate shape in an axial direction, and said at least two attachment portions are each arranged at one end of the flexible substrate in the axial direction.

5. The trim element according to claim 1, wherein the attachment portion has:
a first interface surface in contact with the flexible substrate,
a second interface surface arranged to be in contact with the fastening interface, wherein the first interface surface is greater than the second interface surface, preferably the first interface surface is greater than 120% of the second interface surface, preferably the first interface surface is greater than 160% of the second interface surface, preferably the first interface surface is greater than twice the second interface surface.

6. The trim element according to claim 1, wherein the attachment portion is attached to the flexible substrate by gluing and/or adhesive and/or welding and/or overmolding.

7. The trim element according to claim 1, wherein the attachment portion is at least partially arranged in a fold of the flexible substrate or in a return fold of the flexible substrate.

8. The trim element according to claim 1, comprising an adhesive film arranged on the flexible substrate and arranged at least in part between the flexible substrate and the attachment portion.

9. The trim element according to claim 1, wherein the attachment portion is arranged to engage on the fastening interface, by resilient or sliding engagement.

10. The trim element according to claim 7, wherein the sliding engagement is arranged to take place in a direction parallel to a direction of application of a force for mounting the trim element on the vehicle steering wheel or in a direction parallel to an axial or longitudinal direction of the flexible substrate or the trim element.

11. The trim element according to claim 1, wherein the flexible substrate comprises or forms an electrically conductive element.

12. The trim element according to claim 11, wherein the flexible substrate comprises or forms a heating element or comprises or forms an element forming part of a capacitive detection sensor.

13. The trim element according to claim 1, wherein the flexible substrate comprises or forms a decorative element, arranged to be visible, such as an outer casing of the vehicle steering wheel.

14. A vehicle steering wheel comprising:
at least one trim element according to claim 3,
a fastening interface, formed in a foam of the vehicle steering wheel or in an insert of the steering wheel and separate from the foam, wherein the fastening interface receives or interfaces at least partially with the two attachment portions.

15. The trim element according to claim 2, comprising at least two attachment portions, at least one of said at least two attachment portions is arranged to be attached, at least during part of an operation for mounting the trim element on the vehicle steering wheel, to a dedicated fastening portion of the fastening interface of the vehicle steering wheel.

16. The trim element according to claim 2, wherein the attachment portion has:
a first interface surface in contact with the flexible substrate,
a second interface surface arranged to be in contact with the fastening interface, wherein the first interface surface is greater than the second interface surface, preferably the first interface surface is greater than 120% of the second interface surface, preferably the first interface surface is greater than 160% of the second interface surface, preferably the first interface surface is greater than twice the second interface surface.

17. The trim element according to claim 3, wherein the attachment portion has:
a first interface surface in contact with the flexible substrate,
a second interface surface arranged to be in contact with the fastening interface, wherein the first interface surface is greater than the second interface surface, preferably the first interface surface is greater than 120% of the second interface surface, preferably the first interface surface is greater than 160% of the second interface surface, preferably the first interface surface is greater than twice the second interface surface.

18. The trim element according to claim 4, wherein the attachment portion has:
a first interface surface in contact with the flexible substrate,
a second interface surface arranged to be in contact with the fastening interface, wherein the first interface surface is greater than the second interface surface, preferably the first interface surface is greater than 120% of the second interface surface, preferably the first interface surface is greater than 160% of the second interface surface, preferably the first interface surface is greater than twice the second interface surface.
